(19) United States
(12) Patent Application Publication
(10) Pub. No.: US 2018/0067195 A1
(43) Pub. Date: Mar. 8, 2018

(54) MULTI-TIER LIGHT-BASED RANGING SYSTEMS AND METHODS

(71) Applicant: QUALCOMM Incorporated, San Diego, CA (US)

(72) Inventors: Volodimir Slobodyanyuk, San Diego, CA (US); John Wyrwas, Mountain View, CA (US); Manav Raina, San Diego, CA (US); Linda Irish, San Diego, CA (US)

(21) Appl. No.: 15/260,031

(22) Filed: Sep. 8, 2016

(51) Int. Cl. G01S 7/481; G01S 17/10

(52) U.S. Cl. CPC G01S 7/4815; G01S 17/10; G01S 7/4817

(57) ABSTRACT

Methods, systems, computer-readable media, and apparatuses for multi-tier light-based ranging are presented. One example method includes determining a first operating environment; selecting a first set of laser emitters from a plurality of sets of laser emitters based on the first operating environment, the first set of laser emitters having a first angular FOV and a first effective range; detecting one or more objects within the first angular FOV based on detected reflected laser light; determining a second operating environment different from the first operating environment; selecting a second set of laser emitters from the plurality of sets of laser emitters based on the second operating environment, the second set of laser emitters having a second angular FOV narrower than the first angular FOV and a second effective range greater than the first effective range; and detecting one or more objects within the second angular FOV based on detected reflected laser light.

### BACKGROUND

Laser-based, e.g., LIDAR, range finding devices may be used to detect the presence of, and distance to, objects within a field of view (“FOV”) of the device. A laser device is positioned adjacent to an optical sensor such that it emits light at a predetermined offset. The laser device projects laser light into the FOV and reflected laser light is captured by the optical sensor. The captured reflected laser light may then be used to determine the location and distance to an object within the FOV.

### BRIEF SUMMARY

Various examples are described for multi-tier light-based ranging systems and methods. One disclosed method includes determining a first operating environment based on first environment information; selecting a first set of laser emitters from a plurality of sets of laser emitters based on the first operating environment, each of the sets of laser emitters oriented to emit laser light in a forward direction, the first set of laser emitters having a first angular field of view (“FOV”) and having a first effective range; detecting one or more objects within the first angular FOV based on detected reflected laser light emitted from the laser emitters of the first set of laser emitters and received at a receiver; determining a second operating environment based on second environment information, the second operating environment different from the first operating environment; selecting a second set of laser emitters from the plurality of sets of laser emitters based on the second operating environment, the second set of laser emitters oriented to emit laser light in the forward direction and having a second angular FOV narrower than the first angular FOV and a second effective range greater than the first effective range; and detecting one or more objects within the second angular FOV based on detected reflected laser light emitted from the laser emitters of the second set of laser emitters and received at the receiver.

One disclosed system includes a first laser subsystem comprising a first laser emitter to emit one or more first laser light; and a first beam deflector configured to cause the first laser light to be projected into a first field of view (“FOV”); a second laser subsystem including a second laser emitter to emit one or more second laser light; and a second beam deflector configured to cause the second laser light to be projected into a second FOV, the second FOV overlapping a portion of the first FOV and being narrower than the first FOV; a single light receiver subsystem configured to receive reflected first laser light and reflected second laser light from the first and second FOVs, respectively, the single light receiver comprising a light sensor configured to generate one or more sensor signals in response to being illuminated one or more reflected laser light, and a computing device to receive the one or more sensor signals from the laser detector; and determine the presence of an object in the first or second FOV, or in both the first and second FOVs based, at least in part, on the one or more sensor signals.

One example non-transitory computer-readable medium comprising processor-executable program code configured to cause a processor to: determine a first operating environment based on first environment information; select a first set of laser emitters from a plurality of sets of laser emitters based on the first operating environment, each of the sets of laser emitters oriented to emit laser light in a forward direction, the first set of laser emitters having a first angular field of view (“FOV”) and having a first effective range; detect one or more objects within the first angular FOV based on detected reflected laser light emitted from the laser emitters of the first set of laser emitters and received at a receiver; determine a second operating environment based on second environment information, the second operating environment different from the first operating environment; select a second set of laser emitters from a plurality of sets of laser emitters based on the second operating environment, the second set of laser emitters oriented to emit laser light in the forward direction and having a second angular FOV narrower than the first angular FOV and a second effective range greater than the first effective range; and detect one or more objects within the second angular FOV based on detected reflected laser light emitted from the laser emitters of the second set of laser emitters and received at the receiver.

One example apparatus includes means for determining a first operating environment based on first environment information; means for selecting a first set of laser emitters from a plurality of sets of laser emitters based on the first operating environment, each of the sets of laser emitters oriented to emit laser light in a forward direction, the first set of laser emitters having a first angular field of view (“FOV”) and having a first effective range; means for detecting one or more objects within the first angular FOV based on detected reflected laser light emitted from the laser emitters of the first set of laser emitters and received at a receiver; means for determining a second operating environment based on second environment information, the second operating environment different from the first operating environment; means for selecting a second set of laser emitters from a plurality of sets of laser emitters based on the second operating environment, the second set of laser emitters oriented to emit laser light in the forward direction and having a second angular FOV narrower than the first angular FOV and a second effective range greater than the first effective range; and means for detecting one or more objects within the second angular FOV based on detected reflected laser light emitted from the laser emitters of the second set of laser emitters and received at the receiver.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for multi-tier light-based ranging;

FIG. 3 shows an example computing device for multi-tier light-based ranging;

FIG. 4 shows an example system for multi-tier light-based ranging;

FIGS. 5-7 show example operating environments for multi-tier light-based ranging; and

FIG. 8 shows an example method for multi-tier light-based ranging.

### DETAILED DESCRIPTION

Examples are described herein in the context of multi-tier light-based ranging systems and methods. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

### Illustrative Example of Multi-Tier Light-Based Ranging Systems and Methods

In this illustrative example, a vehicle is equipped with a multi-tier light-based ranging system that provides information to an autonomous driving system in the vehicle. In this example, the vehicle employs a multi-tier LIDAR-based system. As the vehicle travels along its route, the multi-tier LIDAR system scans the road ahead of the vehicle to identify objects in the vehicle's path or changes in road's direction and provides the object information to the autonomous driving system.

This example multi-tier LIDAR system employs two sets of laser emitters with both sets oriented to project laser light into the path in front of the vehicle. The first set of laser emitters emits laser light that is projected onto a wide-angle FOV, via beam deflectors, of approximately 120 degrees. The beam deflectors cause the emitted laser light to be projected in different directions over time, allowing the multi-tier LIDAR system to, for example, sweep laser light across the wide-angle FOV. In addition, the multi-tier LIDAR system provides sufficient power to the first set of laser emitters to enable an effective range for the laser light of approximately 100 meters.

The second set of laser emitters also emits laser light, but unlike the first set of laser emitters, this laser light is projected onto a narrow-angle FOV of approximately 15 degrees via beam deflectors. However, the multi-tier LIDAR system provides sufficient power to the first set of laser emitters to enable an effective range for the laser light of approximately 300 meters. In this context, it should be appreciated that “effective range” relates to emitting sufficiently-strong laser light that, if it reflects from an object 300 meters from the detector, reflected laser light returns to the system with sufficient strength to be detected and identified as reflected laser light emitted by one or more of the laser emitters. Thus, the first set of laser emitters provides a wide angle, but short range, FOV, while the second set of laser emitters provides a narrow angle, but longer range, FOV.

The first and second sets of laser emitters are arranged such that they emit light at predetermined distances from a light sensor. For example, the laser light strikes a beam deflector that projects the laser light into the FOV at a known offset from the light sensor. In addition, each laser emitter is driven by a circuit that modulates the laser light according to a particular frequency, with each set of laser emitters modulated at a different frequency, which allows the multi-tier LIDAR system to discriminate between laser light emitted by the multi-tier LIDAR system and other ambient light sources, including other LIDAR systems.

As laser light is projected into one (or both) of the two angular fields of view in front of the vehicle, some of the laser light may reflect off of objects, such as other vehicles, and back towards the multi-tier LIDAR system. Such reflected laser light may be sensed by the light sensor and used to detect one or more objects in the angular field(s) of view.

Because the two different sets of laser emitters are arranged to project laser light into different angular fields of view, and have different effective ranges, the LIDAR system may enable one or the other set of laser emitters based on a driving environment. For example, when the vehicle is travelling at a speed below about 55 miles per hour, the LIDAR system may employ the first set of laser emitters, which have a shorter effective range, but a wider angular FOV. This may enable the LIDAR system to operate more effectively in an urban environment where there may be large numbers of nearby objects or objects outside of the road surface may be detected, such as pedestrians, parked cars, bicyclists, buildings, etc. Further, a shorter range system may be adequate to provide information to the autonomous driving system to enable the vehicle to stop for detected objects nearer than 100 meters. Lower speeds typically involve shorter stopping distances, so longer-range LIDAR sensing is of lesser importance. Further, when in the wide angle, but shorter range, mode, the laser emitters emit less powerful laser light, which may reduce a risk of eye injury to any nearby people struck with a laser pulse.

However higher speeds, such as those above 55 miles per hour, may be associated with travel upon a state or interstate highway. In such examples, the autonomous driving system may need longer range information to accommodate effective braking or to detect road curvature. However, in such an environment, information about objects to either side of the road surface is of lesser importance, as fewer objects are typically located or travelling adjacent to the road surface. Thus, a narrower FOV with a longer effective range may be employed to enable an autonomous driving mode.

The LIDAR system is also able to employ both sets of laser emitters 106a-b, 108a-b simultaneously, such as when travelling in heavy traffic on a highway. To enable the LIDAR system to discriminate between laser light from the two different sets of emitters, it alternates laser light from each set of laser emitters in addition to using different modulation schemes for each.

Thus, as the vehicle travels along a route, the LIDAR system may change between different sets of laser emitters depending on driving conditions and the road being travelled. In this example, the vehicle's autonomous driving system, in conjunction with the vehicle's navigation system, enable or disable different sets of laser emitters as appropriate.

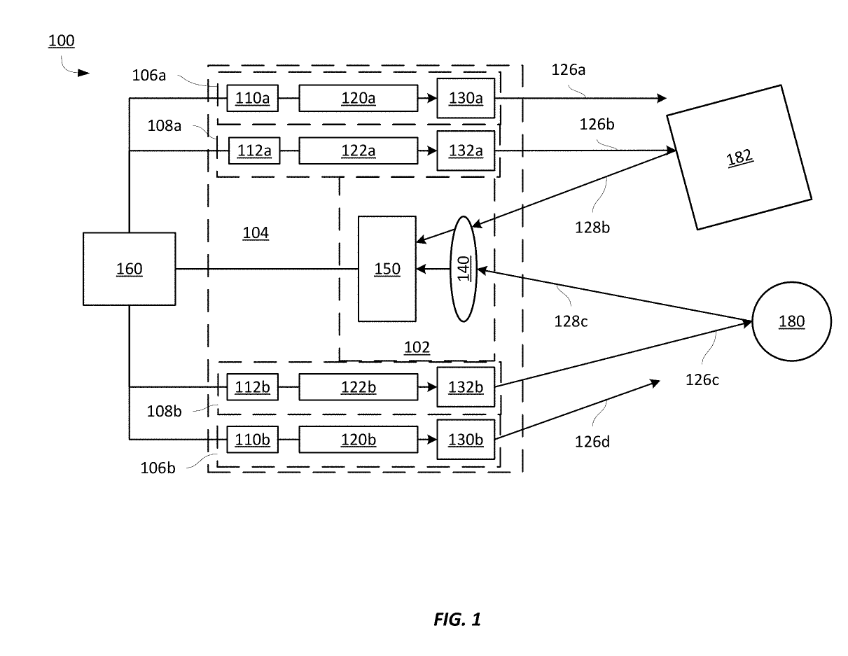

Referring now to FIG. 1, FIG. 1 shows an example system 100 for multi-tier light-based ranging. The system 100 includes a computing device 160 and a light emitter/detector unit 104. In this example, the light emitter/detector unit 104 includes four sets of laser emitter components 106a-b, 108a-b as a part of a multi-tier LIDAR system. Each set of laser emitter components 160a-b, 108a-b in this example includes a laser emitter driver 110a-b, 112a-b a laser emitter 120a-b, 122a-b and a beam deflector 130a-b, 132a-b. In this example system 100, the laser emitter components 106a-b, 108a-b are further grouped into two groups, each arranged to project laser light into different angular fields of view.

The first group of laser emitter components 106a-b, which includes laser emitter drivers 110a-b, laser emitters 120a-b, and beam deflectors 130a-b, is arranged to project laser light into a wide angle FOV. In this example, the wide angle FOV is approximately 120 degrees, which is centered on an axis parallel to a longitudinal axis of a machine on which the system 100 is mounted. Thus, each of the two laser emitters 120a-b projects light on the beam deflectors, which sweep the laser light across a FOV of approximately 120 degrees, providing two overlapping fields of view of 120 degrees. And while this example employs a 120 degree FOV, other suitable angular fields of view may be employed, though in most cases a wide angle FOV is at least 90 degrees.

In addition to employing a wide angle FOV, the first group of laser emitter components 106a-b is also configured to have an effective range of approximately 100 meters in front of the vehicle. For example, the laser emitters 120a-b may be driven by an amount of power that limits the range at which reflected laser light may be detected. Or, the laser emitters may emit laser light that diffuses such that reflected laser light from an object beyond 100 meters is too weak to be detected, or is simply filtered out as noise.

The second group of laser emitter components 108a-b, which includes laser emitter drivers 112a-b, laser emitters 122a-b, and beam deflectors 132a-b, is arranged to project laser light into a narrow angle FOV. In this example, the narrow angle FOV is approximately 20 degrees. Thus, each of the two laser emitters 122a-b projects light on the beam deflectors 132a-b, which sweep the laser light across a FOV of approximately 20 degrees, providing two overlapping fields of view of 20 degrees. And while this example employs a 20 degree FOV, other suitable angular fields of view may be employed, though in most cases a narrow angle FOV is less than 90 degrees.

In addition to employing a narrow angle FOV, the second group of laser emitter components 108a-b is also configured to have an effective range of approximately 300 meters. For example, the laser emitters 122a-b may be driven by an amount of power that limits the range at which reflected laser light may be detected to approximately 300 meters in front of the vehicle. Or, the laser emitters may emit laser light that diffuses such that reflected laser light from an object beyond 300 meters is too weak to be detected, or is simply filtered out as noise. And while short and long ranges have been described with respect to effective ranges of 100 and 300 meters, respectively, it should be appreciated that appropriate short and long ranges may be set at different distances based on a particular application.

Further, while the system 100 in FIG. 1 shows a one-to-one correspondence between laser emitter drivers and laser emitters, and between laser emitters and beam deflectors, such a one-to-one correspondence is not required. Rather, one or more laser emitter drivers or beam deflectors may be shared by two or more laser emitters according to different examples. For example, a single laser emitter driver may be configured to output multiple drive signals.

In this examples, the output of the beam deflectors 130a-b, 132a-b are evenly spaced along the same horizontal plane at predetermined distances from a light sensor. However, in some examples, the output of the beam deflectors 130a-b, 132a-b may be arranged in one or more horizontal or vertical planes to increase the coverage of either or both FOVs by emitted laser light. Further in some examples, different numbers of laser emitters may be employed. While four laser emitters 120a-b, 122a-b are depicted in FIG. 1, any number of two or more laser emitters (at least one in each set 106a-b, 108a-b) may be employed in different examples.

The system 100 also includes light receiver components 102, including a lens 140, a light sensor 150, and a computing device 160. In this example, while multiple laser emitters 120a-b, 122a-b are employed, only one light sensor 150 is employed. However, it should be appreciated that any number of light sensors 150 may be employed. For example, the light receiver components 102 may include multiple light sensors arranged in a horizontal or vertical array, or in two-dimensional array of light sensors. In one such example, each individual light sensor is arranged to capture light in an angular FOV smaller than a FOV of the sets of laser emitters, but the combined angular FOVs of the light sensors is sufficient to capture light reflected within the full FOVs of the sets of laser emitters. In some examples having multiple light sensors, two or more of the light sensors may have overlapping fields of view, which may enable the light sensors to better cover the full fields of view of the different laser emitters 120a-b, 122a-b.

In this example, the system 100 includes a lens 140, however, other examples may employ light sensors with integrated lenses or focal elements. The lens 140, in this example, directs light onto the light sensor 150, which generates signals that indicate where on the light sensor 150 light struck. In this example, the light sensor 150 is a position sensing diode, however, any suitable position sensing device may be used. For example, other suitable light sensors include an array of position sensing diodes, or one or more charged-coupled devices (CCD) or CMOS image sensors. The signals are communicated to the computing device 160, which determines whether any objects were detected by reflected laser light.

The computing device 160 transmits signals to the laser emitter drivers 110a-b, 112a-b to cause the laser emitter drivers 110a-b, 112a-b to drive laser emitters 120a-b, 122a-b to emit laser light 126a-d. The computing device 160 may also transmit signals to adjust a modulation frequency of one or more laser emitter drivers 110a-b, 112a-b, or to disable one or more of them. In addition, the computing device 160 receives signals from the light sensor 150 and determines one or more objects 180-182 in one or more FOVs, e.g., the narrow or wide angle FOVs, based on such signals.

During operation, the laser emitters 120a-b, 122a-b, when driven by signals from the corresponding laser emitter driver 110a-b, 112a-b, emit laser light 126a-d, which is deflected by a corresponding beam deflector 130a-b, 132a-b into a FOV, where the laser light may strike an object 180-182, and reflect back 128b-c onto the lens 140. The lens 140 may then direct the light onto the light sensor 150. The light sensor 150 then generate signals based on the received reflected light and transmits them to the computing device.

It should be appreciated that in some examples, the light receiver components 102 may include one or more filters that filter light outside of a range of frequencies generally corresponding to the frequencies of the emitted laser light 126a-d. It should also be appreciated that the frequency of the emitted laser light 126a-d is distinct from a modulation frequency of the emitted laser light 126a-d. For example, a laser emitter that emits red laser light at 450 THz, may modulate that laser light at a frequency of 200 kilohertz (“kHz”) based on a signal from its corresponding laser emitter driver 110a-b, 112a-b.

Suitable modulation frequencies in different examples may be in the range of hundreds of Hz to hundreds of kHz. However, depending on the light sensor 150 employed, modulation frequencies may be adjusted based on the frame rate limits of the position sensing device. For example, while a position sensing diode may support modulation frequencies of hundreds of kilohertz, other position sensing devices, such as CCD or CMOS image sensors may only support modulation frequencies in the range of a few hundred hertz to about 1 kHz.

The laser emitter drivers 110a-b, 112a-b are configured to modulate laser light emitted by the corresponding laser emitter 120a-b, 122a-b based on a modulation signal. In this examples, the laser emitter drivers 110a-b, 112a-b modulate the laser light by varying the intensity of emitted laser light. In some examples, the laser emitter drivers 110a-b, 112a-b may vary an amplitude, phase, frequency, or polarization of the laser light. Further, while the example laser emitter drivers 110a-b, 112a-b shown in FIG. 1 modulate the laser light at a constant frequency, other examples may modulate the laser light by varying a frequency or pulse width of a modulation signal, or varying the modulation signal according to a predetermined pattern, e.g., a bit sequence.

Suitable laser emitters 120a-b, 122a-b may employ any suitable laser emitter device, including visible light lasers, infrared lasers, ultraviolet lasers, etc. In some applications, the strength of emitted laser light may be restricted, for example, in the context of a vehicle where light striking a person's eye may be likely, total (or individual) laser emitter power output may be limited, e.g., to 50 or 100 milliWatts (mW). However, by using multiple laser emitters with a single detector, example systems may be able to achieve better performance than a single emitter paired with a single detector.

The beam deflectors 130a-b, 132a-b include one or more mirrors, and change the orientation of the mirror(s) over time to change the path of emitted laser light into a FOV. For example, a beam deflector 130a-b, 132a-b may oscillate between two orientations. The oscillations may cause the laser light to sweep across a FOV based on the movement of the beam deflector. In some examples, a beam deflector 130a-b, 132a-b may rotate continuously, while only reflecting the light within certain orientations. For example, a mirror may be affixed to or formed on one or more faces of a triangular or polygonal prism, while the other sides may have a substantially non-reflective coating. Rotation of the prism may cause laser light to reflect into a FOV only when it strikes the mirrored side of the prism. Still other styles of beam deflectors may be employed instead.

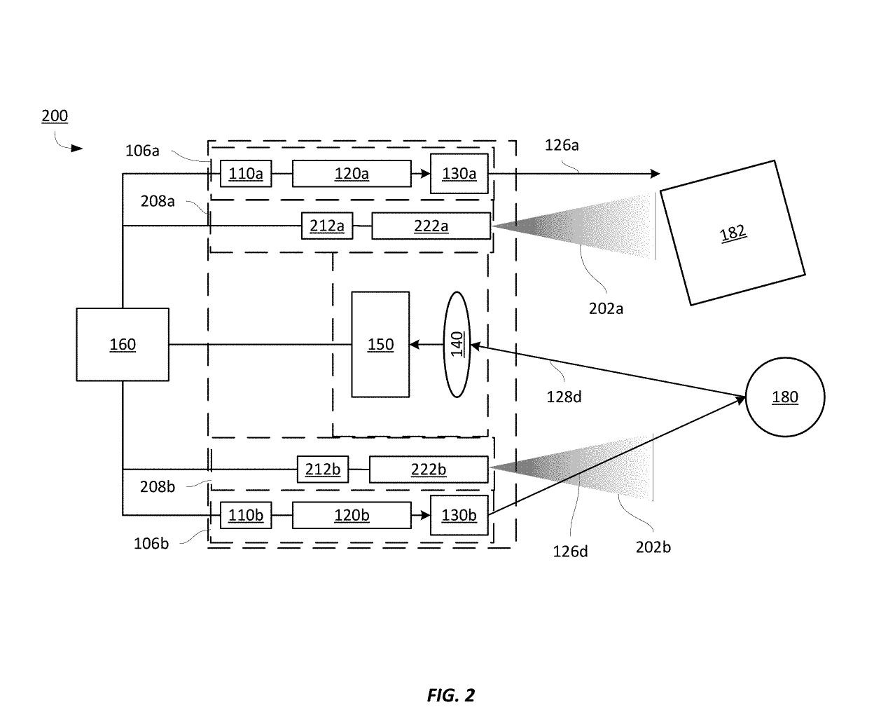

Referring now to FIG. 2, FIG. 2 shows another example system 200 for multi-tier light-based ranging. The example system 200 shown in FIG. 2 includes many of the same components as the example system 100 shown in FIG. 1. But rather than both the wide angle FOV and narrow angle FOV employing laser light reflected by beam deflectors, this example system 200 employs flash laser emitter 222a-b, each driven by a corresponding laser emitter driver 212a-b. In this example, the flash laser emitter 222a-b are configured to emit a pulse of laser light 202b-c spread across a field of view and to then capture reflected light resulting from the emitted light. The light sensor 150 is then able to capture multiple reflected laser light signals simultaneously, which results from the spread pulse of laser light. By substantially simultaneously capturing multiple laser light signals, the flash laser emitters 122a-b in conjunction with the light sensor 150 can be used to detect objects following a single (or small number) of laser light, rather than gradually sweeping laser light across a FOV.

Like the system 100 discussed above with respect to FIG. 1, the system 200 of FIG. 2 uses groups of laser emitter components 106a-b, 208a-b to detect objects in different FOVs. In this example, laser emitters 120a-b, and their associated laser emitter drivers 110a-b and beam deflectors 130a-b, project laser light into a wide angle FOV. In addition, the laser emitter components 106a-b in the wide angle FOV group are configured to have an effective range of approximately 100 meters. In contrast, the flash laser emitters 222a-b, and associated laser emitter drivers 212a-b, projected laser light 202a-b into a narrow angle FOV, but are configured to have an effective range of approximately 300 meters.

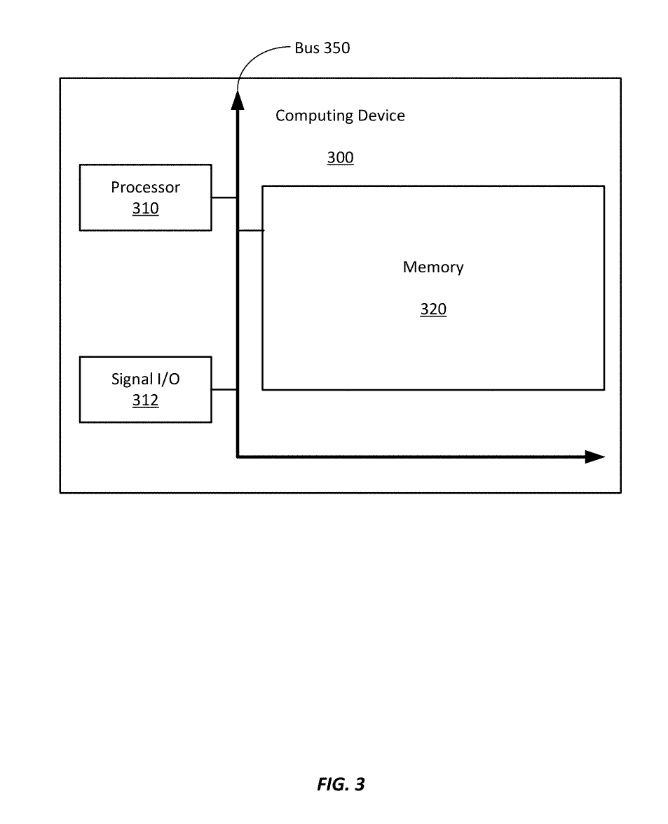

Referring now to FIG. 3, FIG. 3 shows an example computing device 300 suitable for controlling laser emitter components 106a-b, 108a-b, 208a-b, receiving signals from the light sensor 150, and detecting objects based on received sensor signals. In the example shown in FIG. 3, the computing device 300 includes a processor 310, a memory 320, and a signal input/output (“I/O”) interface 312.

The processor 310 is configured to employ bus 350 to execute program code stored in memory 320 to determine objects detected in one or more FOVs based on received reflected light signals, such as reflected laser light originally emitted by one or more of laser emitters 120a-b, 122a-b, 222a-b. In this example, the computing device 300 receives one or more signals from a light sensor, such as light sensor 150 shown in FIGS. 1-2, and executes one or more object detection techniques, such as using a convolutional neural network, to detect one or more objects within a FOV associated with one or both of the groups of laser emitter components. Detection of the one or more objects may include detecting a presence of the object or characteristics of the object, such as a position of the object, a velocity of the object, a size of the object, or a type of the object. For example, the computing device 300 may employ one or more techniques for object detection or recognition to determine one or more characteristics of the object.

For example, systems for multi-tier light-based ranging may determine time of flight (“TOF”) information for received reflected laser light, which may be employed to determine a distance to an object. Further, in some examples, systems for multi-tier light-based ranging may determine an angle to an object based on reflected laser light and a known angle of emission of laser light, e.g., based on an angle of a beam deflector. In one such example, the computing device 300 may detect an object and determine a distance to the object and further an angle to the object based on reflected laser light, which may be used to determine a relative position of the object. Such information may be used to develop information about an environment in which the system is operating, e.g., by identifying objects within the environment and their respective positions. Further, such positions may change over time, e.g., due to motion of the objects themselves or due to motion of a machine equipped with an example system according to this disclosure. Such information may be determined by the computing device 300 and provided to a navigational system of a machine, or it may just be used to map objects in an environment.

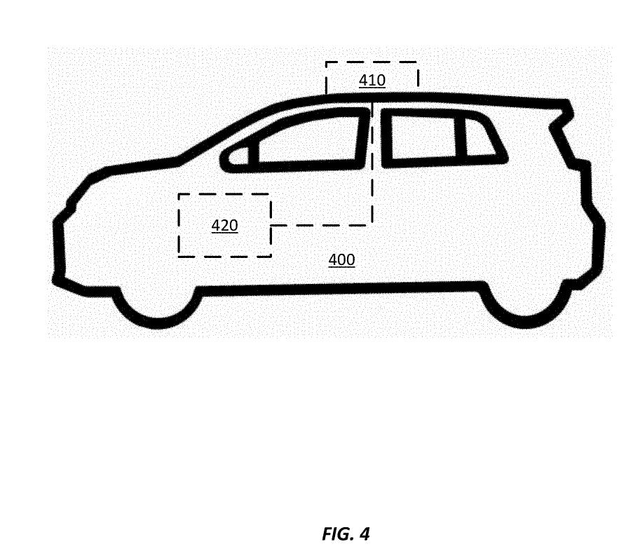

Referring now to FIG. 4, FIG. 4 illustrates a vehicle 400 equipped with an example system 410 for multi-tier light-based ranging. In this example, the system 410 is mounted on a roof of the vehicle 400 and is oriented such that the system's laser emitters project laser light in front of the vehicle 400. However, it should be appreciated that other systems according to this disclosure may be mounted in different orientations, or that multiple suitable systems may be mounted on the vehicle 400.

In this example, the example system 410 for multi-tier light-based ranging is connected to a navigation system 420 of the vehicle 400. In this example, the system 410 for multi-tier light-based ranging receives navigation information from the navigation system, such as a type of road being travelled or a speed of the vehicle 400. The example system 410 for multi-tier light-based ranging may employ such information to change between a wide angle FOV mode and a narrow angle FOV mode, or to simultaneously enable both modes. In some examples, the vehicle 400 may further be equipped with an autonomous driving system (not shown) in communication with the system 410 for multi-tier light-based ranging.

It should be appreciated that in examples when both a wide angle FOV and a narrow angle FOV are enabled simultaneously, a system for multi-tier light-based ranging may only emit laser light from one group of laser emitters at any given time, and may thus alternate between groups of laser emitters. For example, an example system 100 may enable laser emitters 120a-b associated with a wide angle FOV mode to emit laser light and disable laser emitters 122a-b associated with a narrow angle FOV mode. After detecting reflected laser light, the system 100 may disable the laser emitters 120a-b for the wide angle FOV mode and enable the laser emitters 122a-b for the narrow angle FOV mode. The system 100 may then detect reflected laser light from the narrow angle FOV mode laser emitters 122a-b. The system 100 may then alternate between the two modes. Such an alternation scheme may enable the two modes to operate simultaneously without interfering with each other, and may be referred to as “synchronously alternating” between the wide angle FOV mode and the narrow angle FOV mode.

However, in some examples, rather than alternating between groups of laser emitters, an example system 100 may modulate the different groups of laser emitters at different frequencies, and emit laser light from each group of laser emitters at the same or substantially the same time, thus enabling the system to discriminate between received reflected laser light. Thus, use of the term “simultaneously” with respect to activating the wide angle FOV mode and the narrow angle FOV mode does not necessarily mean that both modes are emitting laser light at exactly the same time.

While the example shown in FIG. 4 is of a vehicle 400, it should be appreciated that some example systems according to this disclosure may be suitably equipped on a variety of different types of machines. Machines may be any type of vehicle, such as the vehicle 400 shown in FIG. 4, but may also include mobile or fixed robotic devices, such as autonomous forklifts or robotic equipment on an assembly line. Still other types of machines may employ one or more systems for multi-tier light-based ranging according to this disclosure, e.g., exploratory robots, military-based robotic devices, etc.

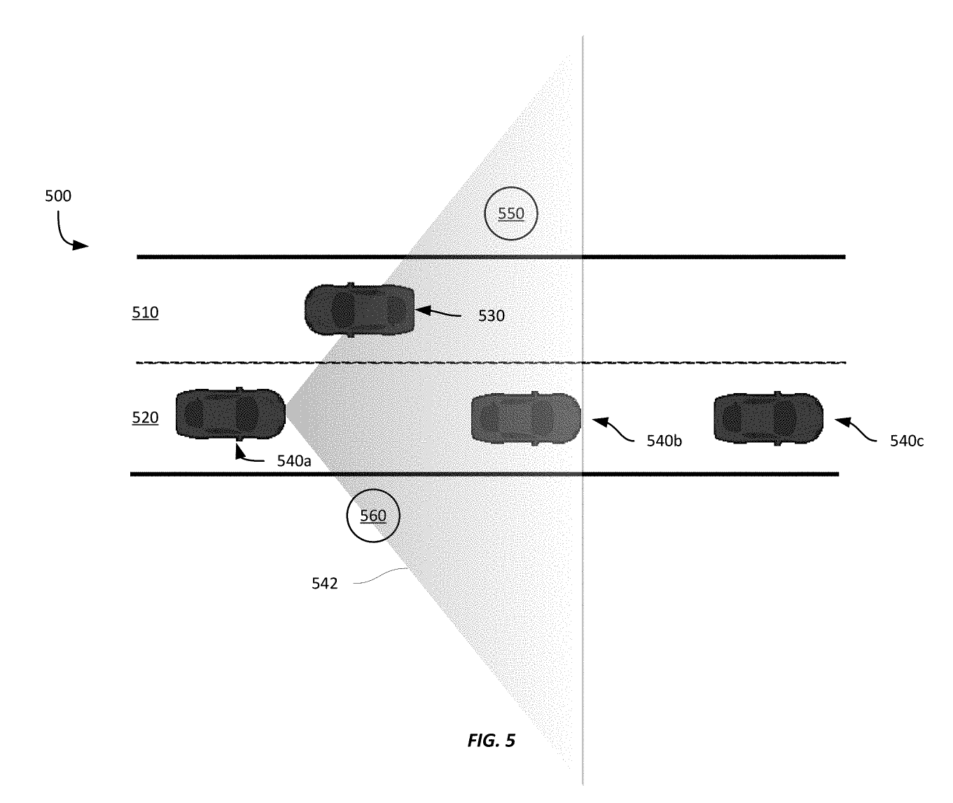

Referring now to FIG. 5, FIG. 5 illustrates an example operating environment for a system for multi-tier light-based ranging installed on an autonomous vehicle 540a. Reference will be made with respect to the example system of FIG. 1 for this example. In this example, the autonomous vehicle 540a is travelling along a lane 520 of a two-lane road 500. The autonomous vehicle 540a is equipped with an example system 100 for multi-tier light-based ranging. The two-lane road 500, in this example, is a city street in a downtown area. Thus, the autonomous vehicle is likely operating within a crowded environment at a relatively slow speed, e.g., less than 55 miles per hour. Thus, the autonomous vehicle configures its multi-tier light-based ranging system 100 to operate in a wide angle mode.

As discussed above, laser emitter components 106a-b operating over a wide angle FOV may be configured to operate with an effective range that is shorter than the laser emitter components operating over a narrow angle FOV. In this example, while operating in a wide angle FOV mode, the example multi-tier light-based ranging system 100 has an effective range of approximately 100 meters. But while operating in a narrow angle FOV mode, it has a range of approximately 300 meters.

In this example, to configure a wide angle FOV mode, the computing device 160 disables the laser emitter drivers 112a-b, which drive the laser emitters 122a-b that emit light into a narrow FOV, and enables the laser emitter drivers 110a-b, which drive the laser emitters 120a-b that emit light into a wide angle FOV. The wide angle FOV group of laser emitter components 106a-b then begins emitting laser light into the wide angle FOV, depicted as a wide angle FOV 542 in FIG. 5. However, in some examples, the system 100 may not disable the laser emitter drivers 112a-b for the narrow angle FOV laser emitters 122a-b, but may instead operate both the wide angle FOV and narrow angle FOV laser emitter components substantially simultaneously.

As is shown in FIG. 5, some laser light emitted into the wide angle FOV strikes the vehicle 530 travelling in the opposite direction in the other traffic lane 510. This laser light is reflected by the vehicle 530 and is detected by the light sensor 150. The light sensor 150 generates image sensor signals and transmits the signals to the computing device 160, which determines the presence and relative location of the other vehicle 530.

In addition, some emitted laser light strikes another car 540b travelling ahead of the vehicle 540a in the same lane 520 of travel. Some of this laser light then is reflected by the vehicle 540b and some is received by the light sensor 150. The light sensor 150 generates one or more image sensor signals based on the received reflected laser light and transmits them to the computing device 160. The computing device 160 then determines the presence and relative location of the other vehicle 540b. However, while a fourth vehicle 540c is present on the road 500, the fourth vehicle 540c is located approximately 150 meters in front of the vehicle 540a, and is beyond the range of the wide angle FOV. Thus, it is not detected.

In addition to detecting other vehicles 530, 540b, the wide angle FOV enables the example system 100 to detect one or more objects, such as pedestrians 550, 560, located to the side of the driving surface of the road 500.

After detecting one or more other vehicles 530, 540b or objects, e.g., pedestrians 550-560, the computing device 160 may then provide information, such as one or more characteristics of the object, e.g., the position, size, type, etc., to a navigation system of the vehicle 540a. The navigation system may then adjust one or more settings in the vehicle 540a, such as a throttle setting, a cruise control setting, or it may engage a system, such as a braking system.

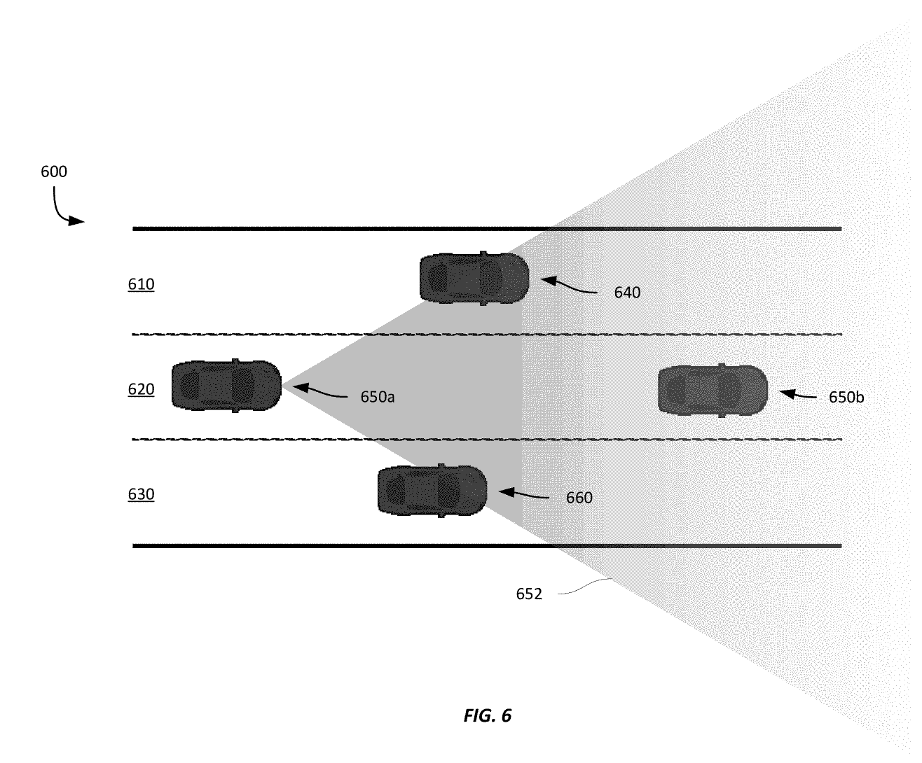

Referring now to FIG. 6, FIG. 6 illustrates another example operating environment for a system for multi-tier light-based ranging installed on an autonomous vehicle 650a. In this example, the vehicle 650a is equipped with an example system for multi-tier light-based ranging, and is travelling on an interstate highway 600 at a high rate of speed, e.g., greater than 55 miles per hour. The computing device 160 receives the speed information from the vehicle, e.g., from the speedometer, and sets the example system into a narrow angle FOV mode and emits laser light into the narrow angle FOV 652.

Similar to the operation of the example system shown in FIG. 5, some laser light emitted into the narrow angle FOV strikes vehicle 640, which is travelling in a travel lane 610 adjacent to the vehicle's lane 610. Some of the laser light is reflected by the vehicle 640 and is detected by the light sensor 150. The light sensor 150 generates image sensor signals and transmits them to the computing device 160, which determines the presence and relative location of the other vehicle 640.

In addition, some emitted laser light strikes other vehicles 650b, 660 travelling ahead of the vehicle 650a in the same or different lanes 520-530 of travel. This laser light then is reflected by the vehicles 650b, 660 and some is received by the light sensor 150. The light sensor 150 generates one or more image sensor signals based on the received reflected laser light and transmits the image sensor signals to the computing device 160. The computing device 160 then determines the presence and relative location of the other vehicles 650b, 660.

In this example environment, unlike the example shown in FIG. 5, the vehicle 650a is travelling on an interstate highway, which has multiple lanes 610-630 of travel in the same direction. Further, in such an environment, there are fewer objects located off of the driving surface, and, in general, the environment may be less crowded than in an urban setting. Thus, an example system for multi-tier light-based ranging may employ a narrow angle FOV mode to obtain higher resolution information about objects in front of the vehicle 650. Such information may be more important as stopping distances are generally increased at higher speeds. Thus, better resolution of objects, which may enable better object recognition, and a longer range of scanning may be enabled by using a narrow angle FOV mode.

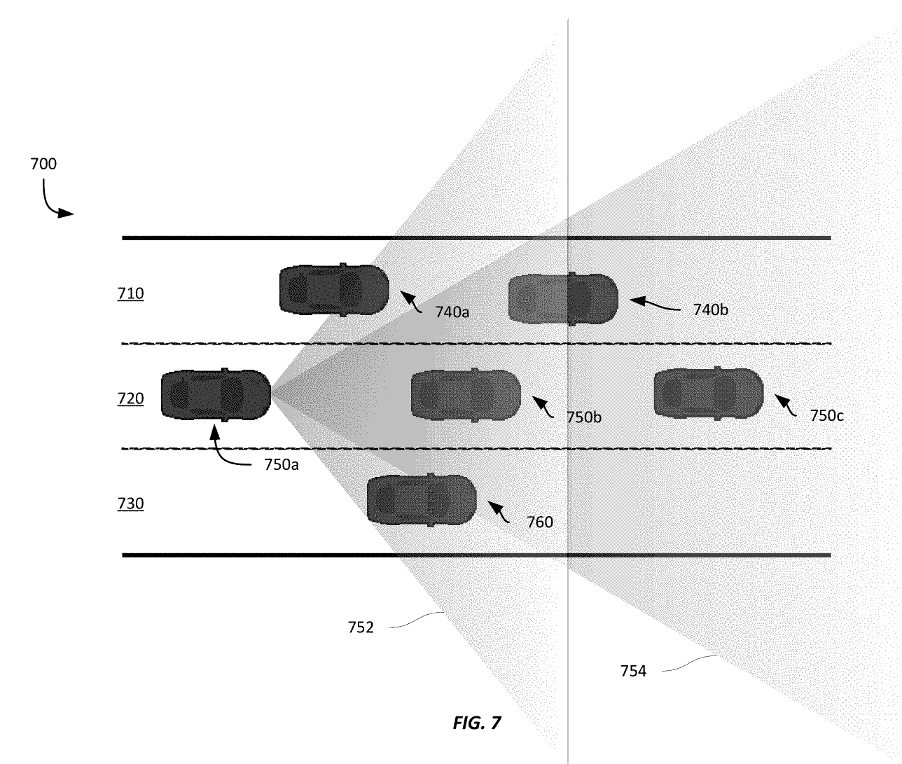

Referring now to FIG. 7, FIG. 7 illustrates a further example operating environment for a system for multi-tier light-based ranging installed on an autonomous vehicle 750a. In this example, like the example shown in FIG. 6, the vehicle 750a is equipped with an example system for multi-tier light-based ranging, and is travelling on an interstate highway 700 at a high rate of speed, e.g., greater than 55 miles per hour. Thus, the computing device 160 sets the example system into a narrow angle FOV mode and emits laser light into the narrow angle FOV 654. However, in this example, the autonomous vehicle 750a simultaneously enables a wide angle FOV mode and emits laser light into the wide angle FOV 752 as well.

In this example, the system for multi-tier light-based ranging detected a significant number of nearby vehicles and the computing device 160 determined that, based on the number of nearby vehicles, despite operating on an interstate highway, the number of nearby vehicles exceeded a threshold value and so the computing device 160 enabled a wide angle FOV mode in addition to the narrow angle FOV mode. In such a configuration, the system for multi-tier light-based ranging may be able to detect nearby vehicles that might otherwise not detected by the narrow angle FOV mode, such as vehicle 740a, which is travelling in a lane 710 adjacent to the vehicle's lane 720, but is near enough to the vehicle 750a that the vehicle 740a is outside of the narrow angle FOV. Thus, while the narrow angle FOV mode detects reflected laser light from other vehicles 740b, 750b-c, 760, the wide angle FOV mode detects reflected laser light from the vehicle 740a nearly adjacent to the vehicle 750a.

In some examples, as discussed above, while the system described with respect to FIG. 7 is simultaneously employing a wide angle FOV mode and a narrow angle FOV mode, it should be appreciated that in some examples, the vehicle may alternate between groups of laser emitters for the different modes, or it may employ another scheme to reduce or prevent interference between received reflected laser light. For example, the different groups of laser emitters 106a-b, 108a-b, 208a-b may be modulated at different frequencies, or may include different types of lasers (e.g., different light frequencies), different polarizations, etc.

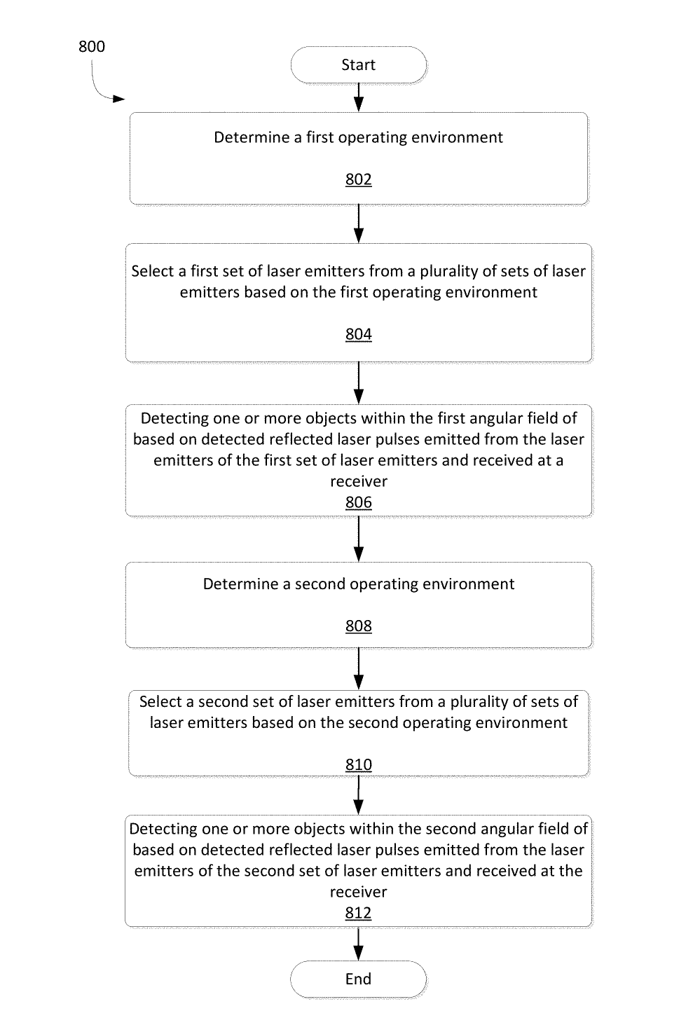

Referring now to FIG. 8, FIG. 8 shows an example method 800 for multi-tier light-based ranging. The method 800 of FIG. 8 will be described with respect to the system shown in FIG. 1, however, it should be appreciated that this example method 800, and any other method according to this disclosure, may be performed by any suitable system according to this disclosure, such as the system 200 shown in FIG. 2.

At block 802, the computing device 160 determines a first operating environment based on first environment information. In this example, the example system 100 is affixed to the roof of a vehicle travelling on a road; however, as discussed above, example systems according to this disclosure may be affixed to any location on any suitable machine in different embodiments. The computing device 160 receives a signal or information from a sensor or system to determine the operating environment. The computing device 160 may receive different types of environment information, such as speed information of the vehicle, location information of the vehicle, etc. Such information may be received from a navigation system or from a vehicle's speedometer via a communications bus, e.g., a car area network (“CAN”) bus. Alternatively, the vehicle may determine its speed from received information, such as gear selection and engine speed. In some examples, the computing device 160 may determine at least some environment information, such as proximity to other objects.

For example, the computing device 160 may detect one or more other vehicles operating on the same road based on received reflected laser light, or it may detect infrastructure objects, such as traffic lights, traffic signs, etc. In some examples, a navigation system may receive location information from a sensor, such as a Global Navigation Satellite System (“GNSS”) (e.g., the Global Positioning System (“GPS”)), and determine the vehicle's location with respect to map information accessible by the navigation system. The navigation system may then determine a road type, such as an interstate highway, a state highway, a downtown city street, a residential street, etc. The navigation system may then provide such information to the computing device 160.

In some examples, the computing device 160 may receive information from an autonomous driving system. Such information may include lane information, infrastructure equipment, parked vehicles, pedestrians, etc. determined, e.g., based on computer vision techniques applied to images captured by one or more cameras mounted on the vehicle.

While this example is discussed with respect to a vehicle operating on a road, in some examples, the system 100 may be affixed to another type of machine. For example, an example system 100 according to this disclosure may be affixed to non-passenger robotic machine, such as automated factory equipment (e.g., a forklift), an autonomously-operated railway vehicle, a bomb disposal robot, a military robotic vehicle, an exploratory robotic vehicle, etc. In such examples, example systems may receive environment information from one or more control or sensor systems associated with such machines. For example, a forklift may receive location or navigation information based on WiFi access points located within a factory or warehouse. Such information may indicate a section of the factory or warehouse the forklift is travelling in, or through, and the forklift may determine an operating context based on such information. For example, a warehouse may have one portion in which people are prohibited, which may allow the forklift to operate an example system 100 in one mode, while other portions of the warehouse may allow for human staff, which may cause the forklift to operate the example system 100 in a different mode.

At block 804, the computing device 160 selects a first set of laser emitters from a plurality of sets of laser emitters based on the first operating environment, each of the sets of laser emitters and their associated components oriented to emit light in a forward direction, the first set of laser emitters 120a-b having a first angular field of view and having a first effective range. As discussed above, the system 100 has two different sets of laser emitters 120a-b, 122a-b and associated components—one set configured to emit laser light into a wide angle FOV and a second set configured to emit laser light into a narrow angle FOV. Further, the laser emitters 120a-b in the wide angle FOV set are configured to emit laser light with an effective range that is shorter than the effective range of the laser emitters 122a-b in the narrow angle FOV set. In this example, the computing device 160 determines a set of laser emitters based on the determined first operating environment.

To determine set of laser emitters, and associated components, to select, the computing device 160 determines characteristics associated with the determined operating environment. For example, characteristics of the first operating environment may include a location of a machine, a speed of a machine, a density of objects in the environment or parameters that may be used to determine the density of objects, types of nearby objects in the environment (e.g., people, vehicles, buildings, equipment, support beams, etc.), a type of operating environment (e.g., residential, rural, commercial, downtown, interstate, parking lot or garage, populated warehouse, unpopulated warehouse, etc.), a user preference, etc. The system 100 may determine values for one or more of the characteristics and calculate a score for the environment by weighting one or more such values and summing the weighted values.

For example, the computing device 160 may be configured to heavily weight a density of objects characteristic, e.g., by assigning a weight of 90 out of 100, while applying a low weight to a speed, e.g., by assigning a weight of 10 out of 100. Such a configuration may be desirable to ensure safe operation of a machine when a large number of objects are detected nearby. In other examples, rather than using weights, a characteristic may be a binary determination, e.g., a density of objects is either “dense” or “not dense,” based on a threshold number of objects detected in the environment. Or rather than using a binary value, a variety of thresholds may be established, enabling a characteristic to have several discrete values, e.g., very dense, moderately dense, light density, no density. Further, some values, e.g., speed, may be integer or continuous values, while other values may be one of a predefined group of values, e.g., a type of operating environment may have a predefined list of types.

Based on such characteristics, the computing device 160 selects a set of laser emitters. In one example, the computing device 160 selects a set of laser emitters in a wide FOV set based on an operating environment having particular characteristics, such as a slow speed (e.g., below a “slow” threshold value), a high density of objects, and a downtown environment. Such characteristics may indicate that a wide FOV should be used to detect objects, e.g., people, that are near the vehicle, but are not in the roadway, or to detect parked vehicles on the road. In such an example, the computing device 160 may select a set laser emitters associated with a wide angle FOV. However in some examples, the computing device 160 may determine the operating environment to have characteristics including being an interstate highway, a high speed, and a low density of nearby objects. In one such example, the computing device 160 may select a set of laser emitters associated with a narrow angle FOV.

At block 806, the computing device 160 detects one or more objects within the first angular field of view based on detected reflected laser light emitted from the laser emitters 120a-b of the first set of laser emitters and received at the light receiver components 102. In this example, reflected laser light are received by the light sensor 150, which generates and transmits sensor signals to the computing device 160. The computing device 160 receives the sensor signals and executes one or more object detection techniques, such as using a convolutional neural network, to detect one or more objects within a FOV associated with the selected set of laser emitters 120a-b. In this example, the light sensor 150 employs a filter to attenuate received light at frequencies outside of the frequencies of laser light emitted by the laser emitters 120a-b, 122a-b. In addition, the light sensor 150 may differentiate one or more laser light emitted from different laser emitters 120a-b, 122a-b based on a modulation of the laser light within the laser light, as described above.

As discussed above, the computing device 160 may detect a presence of an object or a distance to a detected object, e.g., based on TOF information. In some examples, the computing device 160 may also perform one or more object recognition techniques based on the received sensor signals from the light sensor. Two-dimensional or three-dimensional object recognition techniques may be used according to different examples. In some examples, the computing device 160 may provide information about one or more objects to another system, such as a navigation system or an autonomous machine control system. For example, a mobile robot, e.g., a robotic forklift or an exploratory robot, may be equipped with a suitable system for multi-tier light-based ranging according to this disclosure and may obtain information about objects in an environment from the system. Information about detected may be used to construct a map of the environment, or it may be used to assist with autonomous navigation within the environment.

At block 808, the computing device 160 determines a second operating environment based on second environment information, the second operating environment different from the first operating environment. As discussed above with respect to block 802, the computing device 160 may receive information about an operating environment from one or more sensors or systems within a machine. Such information may be used to determine a new operating environment.

At block 810, the computing device 160 selects a second set of laser emitters from a plurality of sets of laser emitters based on the second operating environment, the second set of laser emitters oriented in the forward direction and having a second angular field of view narrower than the first angular field of view and a second effective range greater than the first effective range. In this example, the computing device 160 selects a second set of laser emitters as discussed above with respect to block 804. In some examples, after selecting the second set of laser emitters, the computing device 160 may disable the first set of laser emitters, such as by transmitting a disable signal or discontinuing an enable signal. However, in some examples, the computing device 160 may continue to employ the first set of laser emitters.

At block 812, the computing device 160 detects one or more objects within the second angular field of based on detected reflected laser light emitted from the laser emitters of the second set of laser emitters and received at the receiver as discussed above with respect to block 806. As discussed above, in some examples, the computing device 160 may disable the first set of laser emitters, and this only receive reflected laser light originated by the second set of laser emitters. However, in some examples where both sets of laser emitters are simultaneously enabled, the system 100 may receive reflected laser light originated by either or both sets of laser emitters to detect one or more objects within the second angular field of view.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method comprising:
determining a first operating environment based on first environment information;
selecting a first set of laser emitters from a plurality of sets of laser emitters based on the first operating environment, each of the sets of laser emitters oriented to emit laser light in a forward direction, the first set of laser emitters having a first angular field of view (“FOV”) and having a first effective range;
detecting one or more objects within the first angular FOV based on detected reflected laser light emitted from the laser emitters of the first set of laser emitters and received at a receiver;
determining a second operating environment based on second environment information, the second operating environment different from the first operating environment;
selecting a second set of laser emitters from the plurality of sets of laser emitters based on the second operating environment, the second set of laser emitters oriented to emit laser light in the forward direction and having a second angular FOV narrower than the first angular FOV and a second effective range greater than the first effective range; and
detecting one or more objects within the second angular FOV based on detected reflected laser light emitted from the laser emitters of the second set of laser emitters and received at the receiver.

2. The method of claim 1, further comprising deselecting the first set of laser emitters in response to determining the second operating environment.

3. The method of claim 1, wherein determining the first or second operating environment is based at least in part on a signal received from a speed sensor, a computer vision sensor, or a navigation system.

4. The method of claim 1, wherein the first angular FOV is at least approximately 120 degrees and the second angular FOV is approximately 90 degrees or less.

5. The method of claim 1, wherein the first effective range is approximately 100 meters and the second effective range is approximately 300 meters.

6. The method of claim 1, further comprising:
emitting first laser light from the first set of laser emitters;
sweeping the first laser light across the first angular FOV;
emitting second laser light from the second set of laser emitters by flashing the laser light within the second angular FOV.

7. The method of claim 1, further comprising modulating laser light emitted by the first set of laser emitters according to a first modulation scheme and modulating laser light emitted by the second set of laser emitters according to a second modulation scheme.

8. The method of claim 1, further comprising synchronously alternating laser light emitted from the first set of laser emitters with laser light emitted from the second set of laser emitters.

9. A system for multi-field-of-view light-based ranging, comprising:
a first laser subsystem comprising:
a first laser emitter to emit one or more first laser light; and
a first beam deflector configured to cause the first laser light to be projected into a first field of view (“FOV”);
a second laser subsystem comprising:
a second laser emitter to emit one or more second laser light; and
a second beam deflector configured to cause the second laser light to be projected into a second FOV, the second FOV overlapping a portion of the first FOV and being narrower than the first FOV;
a single light receiver subsystem configured to receive reflected first laser light and reflected second laser light from the first and second FOVs, respectively, the single light receiver comprising a light sensor configured to generate one or more sensor signals in response to being illuminated one or more reflected laser light, and
a computing device to receive the one or more sensor signals from the light receiver subsystem; and determine the presence of an object in the first or second FOV, or in both the first and second FOVs based, at least in part, on the one or more sensor signals.

10. The system of claim 9, wherein the first FOV extends for a range of approximately 100 meters, and the second FOV extends for a range of approximately 300 meters.

11. The system of claim 10, wherein the computing device is further to selectively initiate transmission of the one or more first laser light to operate in a short range mode, and to selectively initiate transmission of the one or more second laser light to operate in a long range mode.

12. The system of claim 11, wherein the system is attached to a machine, and the processor is further configured to determine whether to operate in the short range mode or the long range mode based, at least in part, on a speed of the machine, a location of the machine, or both the speed of the machine and the location of the machine.

13. The system of claim 9, wherein the light sensor comprises a plurality of light sensors arranged along a plane wherein at least two of the plurality of light sensors are arranged to have an overlap, at least in part, of their respective narrower FOVs.

14. The system of claim 13, wherein at least a portion of the plurality of light sensors is arranged in a two-dimensional array of light sensors.

15. A non-transitory computer-readable medium comprising processor-executable program code configured to cause a processor to:
determine a first operating environment based on first environment information;
select a first set of laser emitters from a plurality of sets of laser emitters based on the first operating environment, each of the sets of laser emitters oriented to emit laser light in a forward direction, the first set of laser emitters having a first angular field of view (“FOV”) and having a first effective range;
detect one or more objects within the first angular FOV based on detected reflected laser light emitted from the laser emitters of the first set of laser emitters and received at a receiver;
determine a second operating environment based on second environment information, the second operating environment different from the first operating environment;
select a second set of laser emitters from a plurality of sets of laser emitters based on the second operating environment, the second set of laser emitters oriented to emit laser light in the forward direction and having a second angular FOV narrower than the first angular FOV and a second effective range greater than the first effective range; and
detect one or more objects within the second angular FOV based on detected reflected laser light emitted from the laser emitters of the second set of laser emitters and received at the receiver.

16. The non-transitory computer-readable medium of claim 15, further comprising deselecting the first set of laser emitters in response to determining the second operating environment.

17. The non-transitory computer-readable medium of claim 15, further comprising program code to determine the first or second operating environment based at least in part on a signal received from a speed sensor, a computer vision sensor, or a navigation system.

18. The non-transitory computer-readable medium of claim 15, wherein the first angular FOV is at least approximately 120 degrees and the second angular FOV is approximately 90 degrees or less.

19. The non-transitory computer-readable medium of claim 15, wherein the first effective range is approximately 100 meters and the second effective range is approximately 300 meters.

20. The non-transitory computer-readable medium of claim 15, further comprising:
emitting first laser light from the first set of laser emitters;
sweeping the first laser light across the first angular FOV;
emitting second laser light from the second set of laser emitters by flashing the laser light within the second angular FOV.

21. The non-transitory computer-readable medium of claim 15, further comprising modulating laser light emitted by the first set of laser emitters according to a first modulation scheme and modulating laser light emitted by the second set of laser emitters according to a second modulation scheme.

22. The non-transitory computer-readable medium of claim 15, further comprising synchronously alternating laser light emitted from the first set of laser emitters with laser light emitted from the second set of laser emitters.

23. An apparatus comprising:
means for determining a first operating environment based on first environment information;
means for selecting a first set of laser emitters from a plurality of sets of laser emitters based on the first operating environment, each of the sets of laser emitters oriented to emit laser light in a forward direction, the first set of laser emitters having a first angular field of view (“FOV”) and having a first effective range;
means for detecting one or more objects within the first angular FOV based on detected reflected laser light emitted from the laser emitters of the first set of laser emitters and received at a receiver;
means for determining a second operating environment based on second environment information, the second operating environment different from the first operating environment;
means for selecting a second set of laser emitters from a plurality of sets of laser emitters based on the second operating environment, the second set of laser emitters oriented to emit laser light in the forward direction and having a second angular FOV narrower than the first angular FOV and a second effective range greater than the first effective range; and
means for detecting one or more objects within the second angular FOV based on detected reflected laser light emitted from the laser emitters of the second set of laser emitters and received at the receiver.

24. The apparatus of claim 23, further comprising means for deselecting the first set of laser emitters in response to determining the second operating environment.

25. The apparatus of claim 23, wherein means for determining the first operating environment or the means for determining the second operating environment is further based at least in part on a signal received from a speed sensor, a computer vision sensor, or a navigation system.

26. The apparatus of claim 23, wherein the first angular FOV is at least approximately 120 degrees and the second angular FOV is approximately 90 degrees or less, and wherein the first effective range is approximately 100 meters and the second effective range is approximately 300 meters.

27. The apparatus of claim 23, further comprising:
means for emitting first laser light from the first set of laser emitters;
means for sweeping the first laser light across the first angular FOV;
means for emitting second laser light from the second set of laser emitters by flashing the laser light within the second angular FOV.

28. The apparatus of claim 23, further comprising means for modulating laser light emitted by the first set of laser emitters according to a first modulation scheme and laser light emitted by the second set of laser emitters according to a second modulation scheme.

29. The apparatus of claim 23, further comprising means for synchronously alternating laser light emitted from the first set of laser emitters with laser light emitted from the second set of laser emitters.
